(19) United States
(12) Patent Application Publication
(10) Pub. No.: US 2016/0173936 A1
(43) Pub. Date: Jun. 16, 2016

(54) METHOD AND APPARATUS FOR CHANGING CHANNEL OF SET-TOP BOX

(71) Applicant: SAMSUNG ELECTRONICS CO., LTD., Suwon-si (KR)

(72) Inventor: Chang-joo JUNG, Hwaseong-si (KR)

(21) Appl. No.: 14/964,047

(22) Filed: Dec. 9, 2015

(30) Foreign Application Priority Data
Dec. 12, 2014 (KR) 10-2014-0179355

(51) Int. Cl. H04N 21/438; H04N 21/462; H04N 21/422; H04N 21/643; H04N 21/84; H04N 21/2385; H04N 21/61

(52) U.S. Cl. CPC H04N 21/4384; H04N 21/2385; H04N 21/4383; H04N 21/4622; H04N 21/6125; H04N 21/64322; H04N 21/84; H04N 21/4221

(57) ABSTRACT

A channel changing apparatus for changing a channel of a set-top box is disclosed and includes a network interface configured to obtain meta data including channel information of the set-top box; a receiver configured to receive an input corresponding to a channel to be changed; a controller configured to obtain a channel number corresponding to the input and a maximum number of digits of the channel number using the meta data, and resetting the channel number based on the maximum number of digits of the channel number; and a transmitter configured to transmit the reset channel number to the set-top box.

### CROSS-REFERENCE TO RELATED APPLICATION

This application is based on and claims priority under 35 U.S.C. §119 to Korean Patent Application No. 10-2014-0179355, filed on Dec. 12, 2014, in the Korean Intellectual Property Office, the disclosure of which is incorporated by reference herein in its entirety.

### BACKGROUND

1. Field

The disclosure relates to methods and apparatuses for changing a channel of a set-top box, and for example, to methods and apparatuses for quickly changing a channel of a set-top box.

2. Description of Related Art

A set-top box (STB) refers to an apparatus that is connected to a television (TV) and receives and converts a signal from outside to display content of the signal on the TV.

Recently, as broadcasting has become digitized, a user may easily watch various channels of an Internet Protocol TV (IPTV) or a digital cable TV on a screen of a TV by connecting an external STB to the TV.

When a digital TV is connected to an external STB provided by an IPTV company, a user may change channels using a remote controller of the digital TV.

However, when a channel is changed using a remote controller of a digital TV, it takes a relatively long time to change the channel.

In this regard, there has been a demand for reducing a channel changing time when using a remote controller of a digital TV.

### SUMMARY

Methods and apparatuses for changing a channel of a set-top box in an efficient and fast manner are provided.

Additional aspects will be set forth in part in the description which follows and, in part, will be apparent from the description.

According to an aspect of an example embodiment, a channel changing apparatus that changes a channel of a set-top box includes a network interface (e.g., network interface circuitry) configured to obtain meta data including channel information of the set-top box; a receiver configured to receive an input corresponding to a channel to be changed; a controller configured to obtain a channel number corresponding to the input and a maximum number of digits of the channel number using the meta data, and to reset the channel number based on the maximum number of digits of the channel number; and a transmitter configured to transmit the reset channel number to the set-top box.

In some examples, the controller is configured to adjust a number of digits of the channel number based on the maximum number of digits of the channel number to reset the channel number.

In some examples, the changed channel transmitter may be additionally configured to transmit an operation key input, e.g., an enter key input, to the set-top box consecutively after transmitting the reset channel number.

According to an aspect of another example embodiment, a channel changing apparatus that changes a channel of a set-top box includes a network interface configured to obtain meta data including channel information of the set-top box; a receiver configured to receive an input corresponding to a channel to be changed; a controller configured to obtain a channel number corresponding to the input using meta data, and adding an operation key input, e.g., an enter key input, to the obtained channel number; and a transmitter configured to transmit the channel number to which the operation key input is added to the set-top box.

According to an aspect of another example embodiment, a method of changing a channel of a set-top box includes obtaining meta data including channel information of the set-top box; receiving an input corresponding to a channel to be changed; obtaining a channel number corresponding to the input and a maximum number of digits of the channel number using the meta data; resetting the channel number based on the maximum number of digits; and transmitting the reset channel number to the set-top box.

In some examples, the resetting of the channel number includes adjusting a number of digits of the channel number to reset the channel number based on the maximum number of digits of the channel number.

According to an aspect of another example embodiment, a method of changing a channel of a set-top box includes obtaining meta data including channel information of the set-top box; receiving an input corresponding to a channel to be changed; obtaining a channel number corresponding to the input using the meta data; adding an operation key input, e.g., an enter key input, to the channel number; and transmitting the channel number to which the operation key input, e.g., enter key input, is added to the set-top box.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a diagram illustrating an example digital television (TV) system;

FIG. 2 is a block diagram illustrating an example channel changing apparatus;

FIG. 3 is a flowchart illustrating an example method of changing a channel according to an exemplary embodiment;

FIG. 4 is a flowchart illustrating an example method of changing a channel;

FIG. 5 is a diagram illustrating an example of the digital TV changing a channel of a set-top box (STB) via an infrared communication apparatus, e.g., module; and

FIG. 6 is a diagram illustrating an example of the digital TV connected to an STB via a wireless remote controller.

### DETAILED DESCRIPTION

Terms used herein will be briefly described and the disclosure will be described in greater detail below.

Most of the terms used herein are general terms that have been widely used in the technical art to which the disclosure pertains. However, some of the terms used herein may be created reflecting intentions of technicians in this art, precedents, or new technologies. Also, some of the terms used herein may be arbitrarily chosen. In this case, these terms are defined in detail below. Accordingly, the specific terms used herein should be understood based on the unique meanings thereof and the whole context of the disclosure.

Throughout the disclosure, when a portion “includes” an element, another element may be further included, rather than excluding the existence of the other element, unless otherwise described. The terms, such as ‘unit’ ‘-or/-er’ or ‘module’, should be understood as a unit that processes at least one function or operation and may be embodied by hardware (e.g., circuitry), software, or a combination thereof.

A television (TV) or a TV remote controller may include a multi-brand remote controller (MBR) function. The MBR function refers to a function in which various apparatuses such as a TV, a set-top box (STB), and a DVD player may be controlled by a remote controller. An STB connected to a TV may be controlled by a TV remote controller due to the MBR function.

Conventionally, when changing a channel of an STB using an MBR function of a TV and meta data, a relatively long time is taken to change a channel thereby causing inconvenience to a user. The meta data refers to data information including channel information. For example, a TV may download information about channels provided in an STB, for example, meta data, via an internet server.

For example, when a channel service using the meta data in a digital TV is provided and a user clicks a thumbnail corresponding to a channel, the digital TV may obtain a channel number from the meta data. However, a digital TV does not transmit a channel number in such a manner that an STB immediately changes a channel. Therefore, changing a channel takes a relatively long time.

However, by a method and an apparatus for changing a channel of an STB according to one or more example embodiments of the disclosure, a channel changing time may be reduced since a channel number is transmitted in such a manner that the STB may immediately change the channel, using meta data.

Hereinafter, the disclosure will be described more fully with reference to the accompanying drawings, in which example embodiments of the disclosure are illustrated. This disclosure may, however, be embodied in many different forms and should not be construed as being limited to the example embodiments set forth herein. Rather, these examples are provided so that this disclosure will convey the scope of the disclosed concept to one of ordinary skill in the art. In the disclosure, certain detailed explanations of the related art may be omitted when it is deemed that they may unnecessarily obscure the essence of the disclosure. Like reference numerals denote like elements throughout the various figures and views.

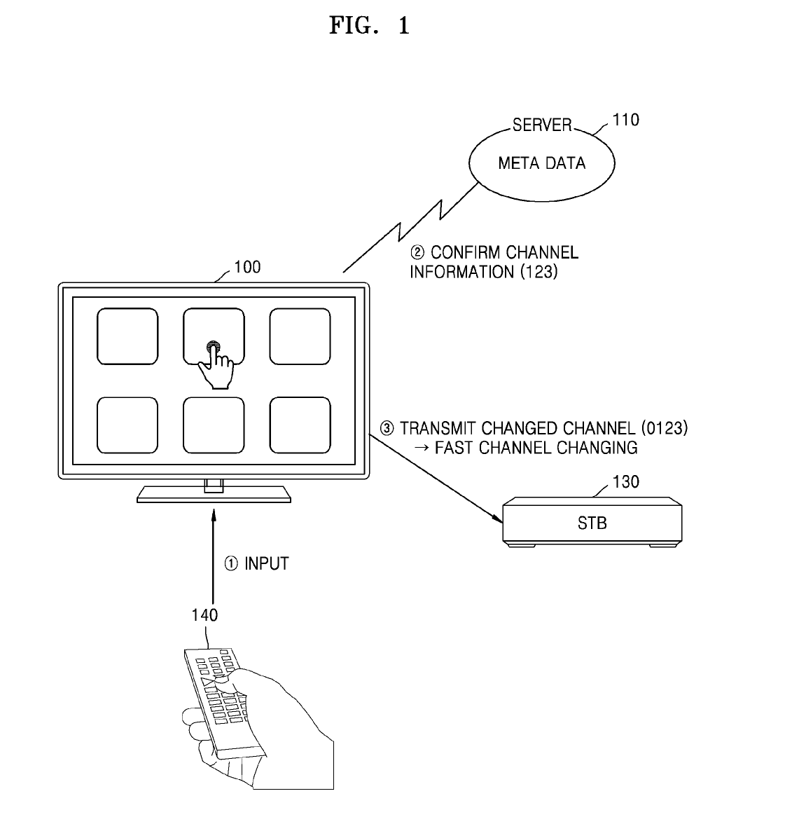

FIG. 1 is a diagram illustrating an example of a digital TV 100 system.

The digital TV 100 as an example of a channel changing apparatus, a server 110 including, for example, meta data, an STB 130, and a remote controller 140 are illustrated in FIG. 1.

As illustrated in FIG. 1, the digital TV 100 according to one or more examples may receive an input for changing a channel via the remote controller 140. A plurality of thumbnails corresponding to a plurality of channels using meta data are displayed on a screen of the digital TV 100. The screen, for example, may be present when an input for a service request for the current popular channel is made via the remote controller 140.

A user may select a thumbnail corresponding to a predetermined channel in a screen of the digital TV 100 to transmit a channel changing request, and then the digital TV 100 may receive the channel changing request. For example, when a plurality of channels using meta data are presented as thumbnails on a screen of the digital TV 100, a user may select a thumbnail corresponding to a predetermined channel via the remote controller 140 to transmit a channel changing request, and then the digital TV 100 may receive the channel changing request.

The digital TV 100 may obtain channel information about a channel selected using meta data. For example, the digital TV 100 may obtain a channel number and a maximum number of digits a channel number selected using meta data. The meta data refers to data information including channel information. For example, the data information may include channel information about all channels that may be changed in the STB 130. The digital TV 100 may obtain information about channels displayed by the STB 130 through meta data. For example, the digital TV 100 may obtain, through meta data, a channel number or the like used in a channel service such as ONTV or ON NOW (a name of a popular channel service), which is displayed by the STB 130.

The meta data may, for example, exist in a server connected to the digital TV 100 and a network, and the digital TV 100 may download the meta data via the network.

The channel number may refer to the number of a broadcast channel. For example, when a channel input is MBC, which is one example of a Korean broadcast channel, a channel number of MBC may, for example, be 11.

The maximum number of digits of a channel number may, for example, be the maximum number of digits of a settable channel number from among channel numbers included in meta data. The maximum number of digits of a channel number may, for example, refer to the largest number of digits that a changeable channel number may have in an STB. For example, when all channel numbers are distributed between 1 and 999 in the STB, the maximum number of digits of a channel number may, for example, be 3 digits. For example, when predetermined channels are allocated from 1 to 999 and no channel is allocated to 1000, the maximum number of digits of a channel number may be 3-digits.

When a user selects a channel thumbnail on a screen of a popular channel service (for example, ONTV or ON Now) that may, for example, be displayed in a set-top box using a remote controller of a digital TV, a time taken to change a channel may be reduced. For example, when a user selects one of channel thumbnails on an ONTV (a service showing a current popular channel) screen displayed in the digital TV 100, the digital TV 100 may obtain a channel number of a channel corresponding to the thumbnail selected by the user using meta data corresponding to ONTV. For example, when a user selects a thumbnail of MNET on a screen, the digital TV 100 may obtain 123, which is a channel number of MNET.

The digital TV 100 may be configured to transmit a channel number of a channel corresponding to a selected thumbnail to the STB 130. The digital TV 100 may obtain the maximum number of digits of a channel number using meta data, and thus transmit the channel number converted to the maximum number of digits to the STB 130.

For example, when 123 is a channel number confirmed by meta data, and the maximum length of the channel digit is 4 digits, the digital TV 100 may convert 123 to 0123 to be transmitted to the STB 130. The digital TV 100 may transmit 0123 and an operation key, e.g., an enter key, input to the STB 130. For example, the STB 130 receiving the converted channel number may directly change a channel, and thus, fast channel changing may be possible. The operation key input, e.g., enter key input, may, for example, correspond to a confirm button of the TV remote controller 140, by which a channel is immediately changed. For example, when a user presses 11 that is a channel number and then the confirm button, a channel of the digital TV 100 is immediately changed to 11. The enter (operation key) input transmitted from the digital TV 100 to the STB 130 may serve the same role as described above.

In a conventional method, a digital TV transmits 123 to an STB and waits for 2 seconds, the STB changes a channel. A digital TV may transmit 123 to an STB, waits for 2 seconds, and additionally transmits an operation key input, e.g., an enter key input, and then the STB changes a channel.

However, a channel changing method and a channel changing apparatus according to one or more example embodiments may provide channel changing without a delay. Hereinafter, a transmitting method according to one or more examples of the disclosure will be described with reference to drawings.

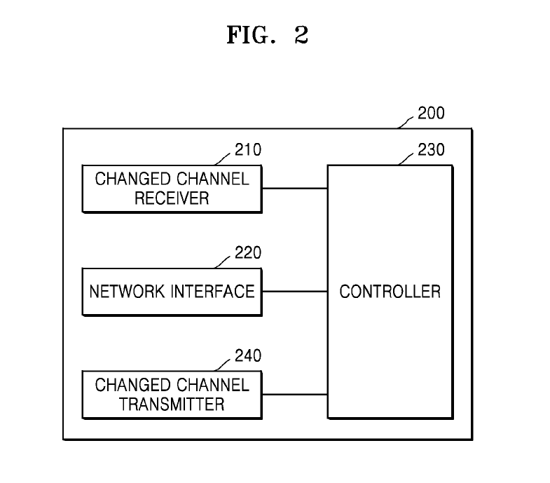

FIG. 2 is a block diagram illustrating an example channel changing apparatus.

Referring to FIG. 2, a channel changing apparatus 200 may include a changed channel receiver (e.g., including receiver circuitry) 210, a network interface 220, a controller 230, and a changed channel transmitter (e.g., including transmitter circuitry) 240. However, all of components illustrated in FIG. 2 are not always needed. The channel changing apparatus 200 may be embodied by more or less components than those illustrated in FIG. 2, and FIG. 2 is provided merely by way of example.

The channel changing apparatus 200 according to one or more examples may be embodied in various forms. For example, the channel changing apparatus 200 described herein may include a digital TV, a smart TV, an apparatus attached to a digital TV, a module included in a digital TV, etc., but embodiments are not limited thereto. For example, the channel changing apparatus 200 may equally correspond to the digital TV 100 illustrated in FIG. 1.

The network interface 220 may receive meta data including channel information of the STB 130 connected to the digital TV 100 via a network. The network interface 220 may include, for example, at least one of a wired network module, and a WiFi module, and receive meta data via a internet server. The meta data may include channel information about all channels that may be changed in the STB 130.

The changed channel receiver 210 may include, for example, receiver circuitry configured to receive a channel to be changed from, for example, a user via various remote controllers, for example, a Bluetooth (BT) remote controller, a radio-frequency (RF) remote controller, an infrared (IR) remote controller, or the like. The changed channel receiver 210 may include, for example, a Bluetooth and an infrared receiving apparatus/circuitry. In some examples, the changed channel receiver 210 may receive an input for a predetermined channel from a Bluetooth remote controller via Bluetooth.

For example, when a plurality of channels using meta data are presented as thumbnails on a screen of the digital TV 100, a user may select a thumbnail corresponding to a predetermined channel via the remote controller 140 to transmit a channel changing request, and thus the changed channel receiver 210 may receive the channel changing request.

The controller 230 may generally be configured to control overall operations of the channel changing apparatus 200. For example, the controller 230 may be configured to perform programs stored in a memory (not shown) and thus, control overall operations of the changed channel receiver 210, the network interface 220, the changed channel transmitter 240, the memory, and the like.

The controller 230 may be configured to obtain a channel number corresponding to a channel input from using meta data. In addition, the controller 230 may be configured to obtain the maximum number of digits of a changeable channel number using meta data.

The controller 230 may be configured to reset a channel number based on the obtained maximum number of digits of the channel number.

In some examples, the controller 230 may be configured to adjust and reset a length of the channel number based on the maximum number of digits of the channel number. For example, when a channel number is 11 and the maximum number of digits of the channel number is 4 digits, the controller 230 may be configured to adjust and reset the channel number to be 0011. The controller 230 may be configured to transmit the reset channel number to the changed channel transmitter 240.

The controller 230 may be configured to add an operation key input, e.g., an enter key input, to the adjusted channel number and reset the channel number. For example, the controller 230 may be configured to add an operation key input, e.g., an enter key input, to 0011 of the adjusted channel number to reset the channel number. The controller 230 may be configured to transmit the reset channel number to the changed channel transmitter 240.

When the maximum number of digits of a channel number used in an STB is 4 digits, 111 of a channel number is input to the STB, and then the STB waits for an input of an additional digit of the channel number. For example, when 111 of a channel number is input via an MBR function of a TV, an STB waits for several seconds since there is no way to determine which channel, for example, 1112, 1113, or the like, is to be finally input.

In the aforementioned case, when the channel changing apparatus 200 may reset 111 of the obtained channel number to be a 4-digit number, which is 0111 and then transmit 0111 to an STB, the STB may immediately change a channel without waiting for an input of an additional channel digit.

In some examples, when the controller 230 resets 111 to be 0111 and an operation key input, e.g., an enter key input, and is then transmitted, a channel may be immediately changed without waiting for an additional digit of the channel number to be.

When a user inputs a full number of a predetermined channel by clicking digits one by one via a remote controller, the channel changing apparatus 200 may not immediately identify the whole number of the predetermined channel.

However, when thumbnails of channels are presented on a screen of a digital TV and a user selects one of the thumbnails, the channel changing apparatus 200 may immediately identify a full number of the selected predetermined channel through meta data. In this regard, the channel changing apparatus 200 may reset the identified full channel number to be in a form by which an STB may immediately change a channel and then transmit to the STB, As a result, the STB may immediately change a channel without a delay.

The changed channel transmitter 240 may be configured to transmit the reset channel number to an STB. The changed channel transmitter 240 may include, for example, a Bluetooth module, an infrared module, or a wired cable, or the like. For example, the changed channel transmitter 240 may be configured to transmit the reset channel number to an STB via an infrared module.

The changed channel transmitter 240 may, for example, support other short-range communication functions in addition to Bluetooth communication and infrared communication. Short-range communication technology according to one or more examples may include, for example, wireless LAN (Wi-Fi), Bluetooth, Zigbee, Wi-Fi Direct (WFD), ultra wideband (UWB), infrared Data Association (IrDA), or the like, but examples are not limited thereto.

When the channel number reset in the aforementioned manner is transmitted to the STB, the STB may immediately change a channel to the requested channel as described above.

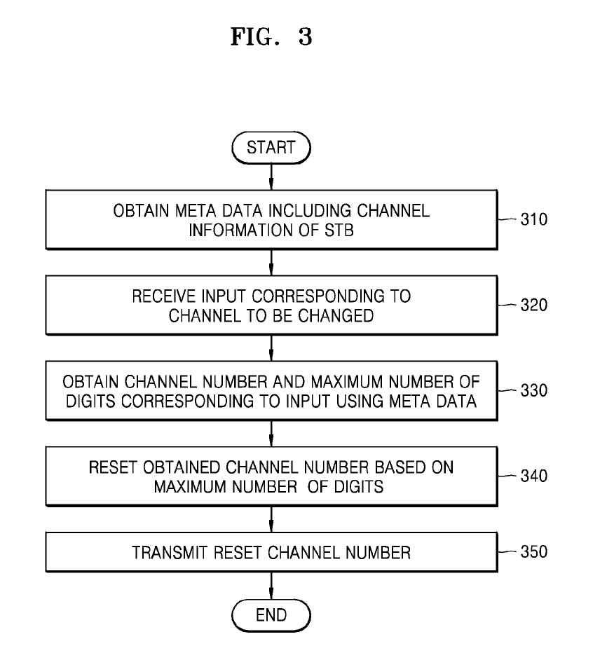

FIG. 3 is a flowchart illustrating an example method of changing a channel.

In operation 310, the channel changing apparatus 200 may obtain meta data including channel information of an STB. The channel changing apparatus 200 may, for example, access a server including meta data via a network to receive the meta data.

In operation 320, the channel changing apparatus 200 may receive an input corresponding to a channel to be changed. For example, when, on an ONTV service screen presenting popular channels, a user selects a thumbnail corresponding to a channel that the user wants to watch via a remote controller, the channel changing apparatus 200 may receive an input corresponding to the channel.

In operation 330, the channel changing apparatus 200 may obtain a channel number and the maximum number of digits of the channel number, corresponding to the input, using meta data. The channel changing apparatus 200 may obtain a channel number corresponding to an input channel from information included in the received meta data. Also, the channel changing apparatus 200 may obtain information on the maximum number of digits of a channel number.

In operation 340, the channel changing apparatus 200 may reset the obtained channel number based on the maximum number of digits of the channel number. For example, when the channel number is 11 and the maximum number of digits of the channel number is 4-digits, the channel changing apparatus 200 may adjust and reset the channel number to be 0011. For example, the channel changing apparatus 200 may transmit the reset channel number to the changed channel transmitter 240.

In addition, the channel changing apparatus 200 may add an operation key input, e.g., an enter key input, to the adjusted channel number to reset the channel number. For example, the channel changing apparatus 200 may add an operation key input, e.g., an enter key input, to 0011 of the adjusted channel number to reset the channel number. For example, the controller 230 may be configured to transmit the reset channel number to the changed channel transmitter 240.

In operation 350, the channel changing apparatus 200 may transmit the reset channel number to an STB.

In some examples, the channel changing apparatus 200 may transmit a channel number whose length is adjusted to an STB, and then consecutively transmit an operation key input, e.g., an enter key input, to the STB. For example, the channel changing apparatus 200 may adjust a channel number 11 corresponding to MBC to be 0011 to be transmitted to an STB and then additionally transmit an operation key input, e.g., an enter key input, to the STB. When a transmission of a channel number and a transmission of an operation key input, e.g., an enter key input, may be consecutively performed, a result thereof may be the same as described in operation 350 in which the channel changing apparatus 200 transmits the reset channel number to the STB.

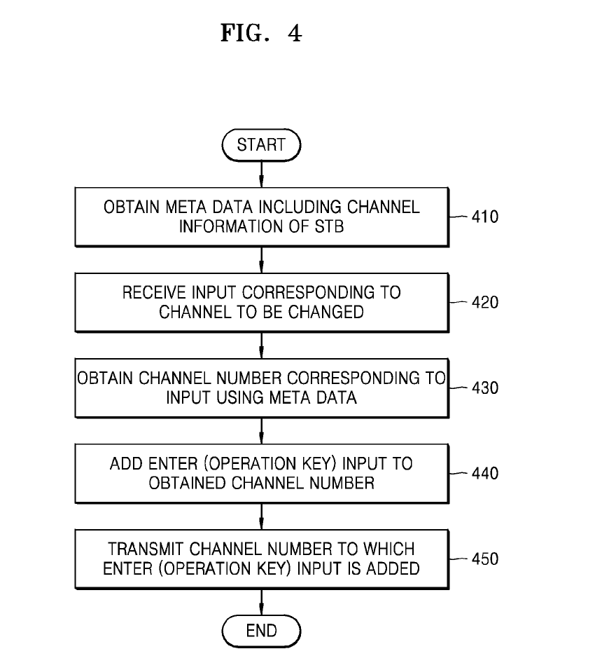

FIG. 4 is a flowchart illustrating an example method of changing a channel.

In operation 410, the channel changing apparatus 200 may obtain meta data including channel information of an STB.

In operation 420, the channel changing apparatus 200 may receive an input of a channel to be changed from a user.

In operation 430, the channel changing apparatus 200 may obtain a channel number corresponding to the input channel using meta data. Operations 410 to 430 are the same as the operations 310 to 330 in FIG. 3 and thus, descriptions thereof will not be repeated.

In operation 440, the channel changing apparatus 200 may add an operation key input, e.g., an enter key input, to the channel number, and in operation 450, the channel number including the enter (operation key) input may be transmitted to the STB.

For example, the channel changing apparatus 200 may add an operation key input, e.g., an enter key input, to 11 of a channel number corresponding to MBC, and both 11 of the channel and the enter (operation key) input may be transmitted to an STB.

In some example embodiments, the channel changing apparatus 200 may transmit the channel number 11 corresponding to MBC, and then, additionally transmit an operation key input, e.g., an enter key input, to an STB.

When a transmission of a channel number and a transmission of an operation key input, e.g., an enter key input, is sequentially performed, the result thereof may be the same as described above. For example, the channel changing apparatus 200 may transmit 11 of a channel number corresponding to MBC and consecutively transmit an operation key input, e.g., an enter key input, to an STB.

In this regard, the STB that receives the channel number 11 and the operation key input, e.g., enter key input, may change a current channel to 11 without waiting for additional reception of any more digits.

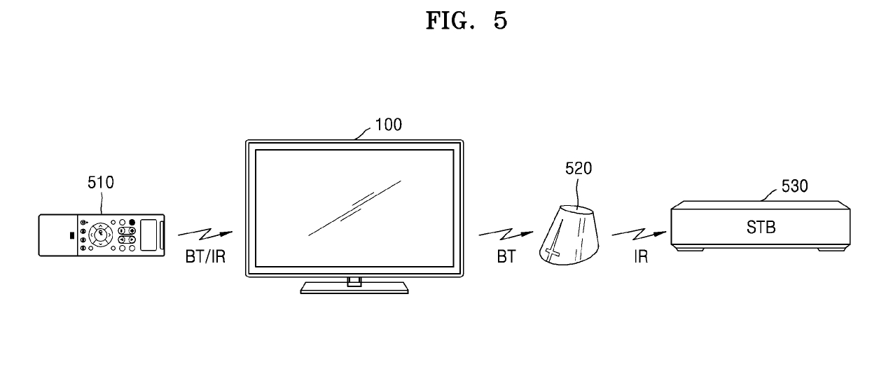

FIG. 5 is a diagram illustrating of an example digital TV changing a channel of an STB via an infrared module.

FIG. 5 illustrates the digital TV 100, a remote controller 510, a BT/IR changing apparatus 520, and the STB 530. The digital TV 100 may equally correspond to the channel changing apparatus 200 in FIG. 2.

When the STB 530 only receives an infrared input, a Bluetooth output of the digital TV 100 may be changed to an infrared ray in the BT/IR changing apparatus 520 to be input in the STB 530.

The digital TV 100 may receive an input corresponding to the changed channel from the remote controller 510 using, for example, Bluetooth or an infrared ray.

The digital TV 100 may transmit a channel number corresponding to a channel to be changed to the BT/IR changing apparatus 520 using Bluetooth, based on the received input. The channel number corresponding to the channel to be changed may be obtained using meta data of a server as described in FIGS. 1 and 2.

The BT/IR changing apparatus 52 may receive a channel number using Bluetooth, and transmit the channel number to the STB 530 using the infrared ray. Here, the digital TV 100 may reset the received channel number based on the maximum number of digits of the channel number, and transmit the reset channel number to the BT/IR changing apparatus 520 using Bluetooth.

The STB 530 receiving the reset channel number may immediately change a channel without waiting for an additional reception of digit(s) of the channel number.

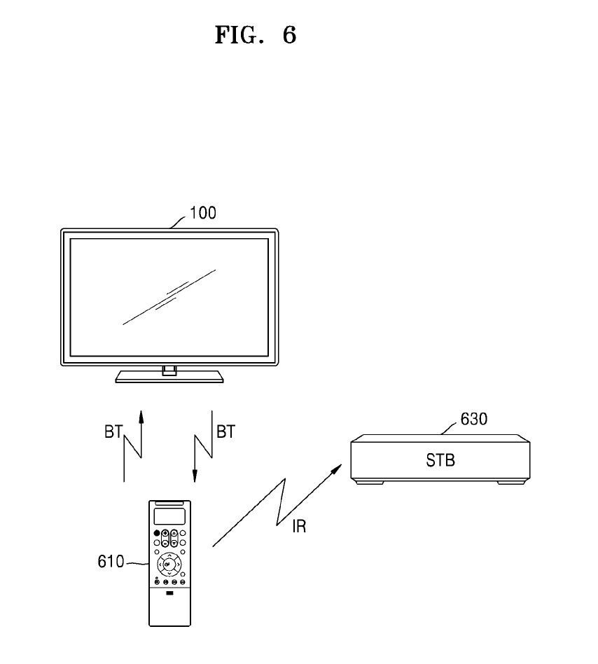

FIG. 6 is a diagram illustrating an example digital TV connected to an STB via a wireless remote controller.

FIG. 6 illustrates the digital TV 100, a BT/IR remote controller 610, and an STB 630. The digital TV 100 may correspond to the channel changing apparatus 200 in FIG. 2.

When an STB only receives an infrared input, a Bluetooth output of the digital TV 100 may be changed to an infrared ray in the BT/IR remote controller 610 to be input in the STB 630.

The digital TV 100 may receive a channel changing request from the BT/IR remote controller 610 using Bluetooth. The digital TV 100 receiving the channel changing request using Bluetooth may reset a channel number based on the maximum number of digits of the channel number, and transmit the reset channel number to the BT/IR remote controller 610 using Bluetooth. The BT/IR remote controller 610 receiving the reset channel number using Bluetooth may transmit the reset channel number to the STB 630 using an infrared ray.

The STB 630 receiving the reset channel number may immediately change a channel without a delay.

The method according to of one or more examples of the disclosure may be implemented as computer instructions which may be executed by various computer means, and recorded on a non-transitory computer-readable recording medium. The non-transitory computer-readable recording medium may include program commands, data files, data structures, or a combination thereof. The program commands recorded on the non-transitory computer-readable recording medium may be specially designed and constructed for the disclosure or may be known to and usable by one of ordinary skill in a field of computer software. Examples of the non-transitory computer-readable recording medium include magnetic media including hard disks, magnetic tapes, and floppy disks, optical media including CD-ROMs and DVDs, magneto-optical media including floptical disks, and hardware designed to store and execute the programmed commands in ROM, RAM, a flash memory, and the like. Examples of the programmed commands include not only machine code generated by a compiler but also include a high-level programming language to be executed in a computer by using an interpreter.

It should be understood that example embodiments described herein should be considered in a descriptive sense only and not for purposes of limitation. Descriptions of features or aspects within each example embodiment should typically be considered as available for other similar features or aspects in other example embodiments. While one or more example embodiments have been described with reference to the figures, it will be understood by those of ordinary skill in the art that various changes in form and details may be made therein without departing from the spirit and scope as defined by the following claims.

What is claimed is:

1. A channel changing apparatus that changes a channel of a set-top box, the channel changing apparatus comprising:
a network interface configured to obtain meta data including channel information of the set-top box;
a receiver configured to receive an input corresponding to a channel to be changed;
a controller configured to obtain a channel number corresponding to the input and a maximum number of digits of the channel number using the meta data, and resetting the channel number based on the maximum number of digits of the channel number; and
a transmitter configured to transmit the reset channel number to the set-top box.

2. The channel changing apparatus of claim 1, wherein the controller is configured to adjust a length of the channel number based on the maximum number of digits of the channel number to reset the channel number.

3. The channel changing apparatus of claim 1, wherein the changed channel transmitter is configured to transmit an operation key input to the set-top box sequentially after transmitting the reset channel number.

4. A channel changing apparatus that changes a channel of a set-top box, the channel changing apparatus comprising:
a network interface configured to obtain meta data including channel information of the set-top box;
a receiver configured to receive an input corresponding to a channel to be changed;
a controller configured to obtain a channel number corresponding to the input using meta data, and adding an operation key input to the obtained channel number; and
a transmitter configured to transmit the channel number to which the operation key input is added to the set-top box.

5. A method of changing a channel of a set-top box, comprising:
obtaining meta data including channel information of the set-top box;
receiving an input corresponding to a channel to be changed;
obtaining a channel number corresponding to the input and a maximum number of digits of the channel number using the meta data;
resetting the channel number based on the maximum number of digits of the channel number; and
transmitting the reset channel number to the set-top box.

6. The method of claim 5, wherein the resetting of the channel number comprises adjusting a length of the channel number to reset the channel number based on the maximum number of digits of the channel number.

7. The method of claim 5, wherein the transmitting of the channel number to the set-top box further comprises transmitting an operation key input to the set-top box sequentially after transmitting the reset channel number.

8. A method of changing a channel of a set-top box, the method comprising:
obtaining meta data including channel information of the set-top box;
receiving an input corresponding to a channel to be changed;
obtaining a channel number corresponding to the input using the meta data;
adding an operation key input to the channel number; and
transmitting the channel number to which the operation key input is added to the set-top box.

9. A non-transitory computer-readable recording medium having recorded thereon a program which, when executed, performs the method of claim 5.

10. A non-transitory computer-readable recording medium having recorded thereon a program which, when executed on a computer, performs the method of claim 6.

11. A non-transitory computer-readable recording medium having recorded thereon a program which, when executed on a computer, performs the method of claim 7.

12. A non-transitory computer-readable recording medium having recorded thereon a program which, when executed on a computer, performs the method of claim 8.

13. The channel changing apparatus of claim 3, wherein the operation key input corresponds to an enter key input.

14. The channel changing apparatus of claim 4, wherein the operation key input corresponds to an enter key input.

15. The method of claim 7, wherein the operation key input corresponds to an enter key input.

16. The method of claim 8, wherein the operation key input corresponds to an enter key input.
